(19) United States
(12) Patent Application Publication
(10) Pub. No.: US 2026/0350380 A1
(43) Pub. Date: Nov. 5, 2026

(54) DYNAMIC PARALLELISM FOR LANGUAGE MODEL INFERENCE

(71) Applicant: NVIDIA Corporation, Santa Clara, CA (US)

(72) Inventors: Nidhi BHATIA, Sunnyvale, CA (US); Ritika BORKAR, Portland, OR (US); Bita Darvish ROUHANI, Santa Clara, CA (US)

(21) Appl. No.: 19/197,339

(22) Filed: May 2, 2025

(51) Int. Cl. G06N 3/063; G06F 9/38; G06N 3/0499; G06N 5/04

(52) U.S. Cl. CPC G06N 3/063; G06F 9/3885; G06N 3/0499; G06N 5/04

(57) ABSTRACT

Various examples relate to dynamic parallelism for language model inference. A pool of processing units is reconfigured between different parallelism modes during inference. In a first mode for attention computation, contextual memory data is distributed across processing units. After attention computation, the units are reprovisioned into a second mode with multi-dimensional parallelism, having tensor parallelism and sparse computation dimensions. The second mode enables processing tokens through neural networks in a sparse computation architecture. For dense models without mixture-of-experts, the sparse computation dimension equals one, allowing graceful degradation to tensor-parallel execution. Collective communication operations may facilitate transitions between modes while maintaining mathematical equivalence with non-distributed computation.

### TECHNICAL FIELD

The present disclosures relate to parallel computing architectures for artificial intelligence and, in some examples, to algorithms and systems to dynamically reprovision processing units between different modes for optimizing parallelism during model inference.

### BACKGROUND

Large language models face significant computational challenges during inference, particularly in the decode phase where tokens are generated one at a time. As models grow in size and context lengths increase, traditional parallelism strategies often struggle to efficiently utilize hardware resources.

For example, the key-value (KV) cache, which stores intermediate computations to avoid redundant processing, grows linearly with sequence length and creates substantial memory pressure. This becomes especially problematic for long-context models targeting millions of tokens, where memory constraints can severely limit performance.

Various parallelism approaches have been developed to address these challenges, including tensor parallelism, pipeline parallelism, and more recently, expert parallelism. Each distributes computational workloads differently across processing units, with different tradeoffs in communication overhead and efficiency.

Modern language models may employ either dense computation, where all parameters process all inputs, or sparse computation through architectures like Mixture-of-Experts (MoE), where only subsets of parameters are activated for each input. These architectural choices significantly impact how computational resources should be allocated for optimal performance.

The field continues to evolve as researchers develop more efficient techniques to balance computational demands, memory usage, and model performance for increasingly capable language models.

### BRIEF DESCRIPTION OF THE DRAWINGS

The present systems and methods are described in detail below with reference to the attached drawing figures. To easily identify the discussion of any particular element or act, the most significant digit or digits in a reference number refer to the figure number in which that element is first introduced. In the drawing figures:

FIG. 1 is a block diagram illustrating an inference pipeline with sequential computational stages for processing language model data, suitable for use in implementing at least some embodiments of the present disclosure;

FIG. 2A and FIG. 2B present a detailed block diagram illustrating a technical implementation of parallelism modes for distributed computation stages in a language model inference system, suitable for use in implementing at least some embodiments of the present disclosure;

FIG. 3 is a block diagram illustrating a dynamic configuration architecture for managing parallel processing resources, suitable for use in implementing at least some embodiments of the present disclosure;

FIG. 4 is a flowchart illustrating a method for implementing dynamic parallelism in a language model inference system, suitable for use in implementing at least some embodiments of the present disclosure;

FIG. 5 is a flowchart illustrating a configuration parameter initialization process for enabling dynamic parallelism, suitable for use in implementing at least some embodiments of the present disclosure;

FIG. 6 is a flowchart illustrating an attention computation phase in a dynamic parallelism system, suitable for use in implementing at least some embodiments of the present disclosure;

FIG. 7 is a flowchart illustrating a dynamic reprovisioning process for transitioning between parallelism modes, suitable for use in implementing at least some embodiments of the present disclosure;

FIG. 8 is a flowchart illustrating a feedforward computation phase in a dynamic parallelism system, suitable for use in implementing at least some embodiments of the present disclosure;

FIG. 9A is a block diagram of an example generative language model system suitable for use in implementing at least some embodiments of the present disclosure;

FIG. 9B is a block diagram of an example generative language model that includes a transformer encoder-decoder suitable for use in implementing at least some embodiments of the present disclosure;

FIG. 9C is a block diagram of an example generative language model that includes a decoder-only transformer architecture suitable for use in implementing at least some embodiments of the present disclosure;

FIG. 10 is a block diagram of an example computing device suitable for use in implementing at least some embodiments of the present disclosure; and

FIG. 11 is a block diagram of an example data center suitable for use in implementing at least some embodiments of the present disclosure.

### DETAILED DESCRIPTION

### Overview

Example systems and methods are disclosed related to parallelism for long context Mixture-of-Experts (MoE) inference decode phase, according to various example embodiments.

Inference may present various challenges during the decode phase of autoregressive generation, regardless of model type (e.g., language model, video models, multi-modal models etc.). These challenges could potentially intensify when dealing with long-context scenarios and sparse computational architectures such as Mixture-of-Experts (MoE). In some example embodiments, these challenges may be addressed through a parallelism approach that reconfigures processing units between different parallelism modes to potentially suit the computational needs of different neural network components.

The decode phase in large language models, for example, may operate in an autoregressive manner, generating one token at a time while maintaining access to previously computed key-value (KV) pairs. As sequence length increases toward targets of millions of tokens, the memory requirements for storing this KV cache will also grow. This growth creates pressure on both memory capacity and bandwidth, particularly when combined with complex model architectures that may employ MoE designs.

Models employing MoE architectures contain multiple specialized neural sub-networks called experts. During inference, each token can be routed to a subset of these experts based on token content. This routing might introduce irregular computation patterns that traditional parallelism strategies could struggle to handle efficiently during decode-time inference. In some embodiments, the routing process involves calculating routing scores that determine the affinity between each input token and available experts in the sparse computation architecture. The routing scores may be computed using learned parameters that measure the compatibility between token features and expert specializations. These scores enable the system to identify which experts are most suitable for processing each particular token

Parallelism approaches, such as Tensor Parallelism (TP), Pipeline Parallelism (PP), and Expert Parallelism (EP), may offer various ways to distribute computation across multiple processing units. However, these approaches can lead to suboptimal hardware utilization when applied uniformly across different computational phases of inference. The attention mechanism and feedforward networks in language models can have different computational characteristics that might benefit from different parallelism strategies.

In some example embodiments, a dynamic parallelism approach uses a set or pool of processing units (e.g., Graphics Processing Units (GPUs), Tensor Processing Units (TPUs), Central Processing Units (CPUs)) etc. and may reconfigure these processing units between multiple distinct parallelism modes to match the computational needs of different neural network components. This approach seeks to enable efficient inference across both dense models and sparse (e.g., MoE, Switch Transformer, Sparsely-Gated Mixture-of-Experts, Sparse Mixture of Local Experts (SMoLE), Routing Networks, Conditional Computation, Adaptive Computation Time (ACT), Dynamic Neural Networks, Hash-based Sparse Networks, and Block-sparse architectures) architectures.

In the first parallelism mode, which might be used during attention computation, example embodiments may implement KV Parallelism (KVP) in a key-value parallelism mode, which distributes the sequence dimension of the KV cache across the available processing units. Each processing unit stores and processes a portion of the total KV cache, enabling a system to handle long context lengths by dividing the memory burden. The processing units might compute key, query, and value projections, attention weights, and outputs in a uniform manner without necessarily distinguishing between tensor parallelism or expert parallelism roles.

The KV Parallelism approach seeks to address several challenges in long-context inference. It might reduce KV streaming pressure by distributing cache shards across processing units. It may increase effective memory bandwidth for KV reads and support scalable KV cache growth without saturating any single processing unit's memory capacity.

After completing the attention computation, example embodiments may transition to a second parallelism mode (e.g., a tensor-expert parallelism mode) for the feedforward computation phase. In this mode, the same pool of processing units may be reconfigured into a multi-dimensional parallelism configuration with tensor parallelism and expert parallelism dimensions. The processing units are organized according to a mathematical relationship where the total number of processing units equals the product of the tensor parallelism degree and the expert parallelism degree.

In this second parallelism mode, each expert is placed on an expert parallelism slice, with its implementation tensor-parallelized across tensor parallelism processing units. Tokens may be routed to their selected experts (e.g., the top-1 or top-2 experts based on routing scores) and processed accordingly within their expert group. This configuration seeks to enable high-compute efficiency within each expert through tensor parallelism while balancing load across experts through expert parallelism.

A routing mechanism may compute routing scores through a learned routing function that evaluates token-expert compatibility. For each token, the system may rank available experts based on their routing scores and select the top-k highest-scoring experts, where k is 1 or 2, for example. This selection process seeks to enable that tokens are processed by the most appropriate expert neural networks while maintaining a bounded compute load per expert. The routing scores may be normalized using techniques such as SoftMax to produce routing weights that sum to 1 across experts.

The transition between these parallelism modes may involve collective communication operations. For example, a system may perform an all-gather operation to aggregate partial attention outputs from each processing unit. The system may then perform a local reduction to combine these outputs and apply a correction operation to maintain mathematical equivalence with non-distributed attention computation. These communication operations might facilitate switching between the parallelism modes.

For models without MoE architectures (or other dense models), example embodiments may handle such cases through adaptation. For example, where the expert parallelism dimension equals one, the second parallelism mode might transition to pure tensor-parallel feedforward execution. This compatibility allows the system to support both dense and sparse model variants using a single implementation path.

The example parallelism approach might apply to various model architectures, including those with recent attention variants such as Multi-Query Attention (MQA), Multi-Head Latent Attention (MLA), and Grouped Query Attention (GQA). These variants may reduce the number of KV heads relative to query heads, which could create mismatches with traditional tensor parallelism approaches. The KV Parallelism component can accommodate these architectural trends by distributing along the sequence dimension rather than the heads dimension.

While particularly beneficial for language models, the dynamic parallelism approach may also be applied to other types of models, including multimodal models that process combinations of text, images, video, and other modalities. For example, a video model may require even larger key-value cache states due to the need to maintain context across video frames. The ability to distribute key-value cache shards across processing units while dynamically reconfiguring for feedforward computation makes it well-suited for such multimodal applications with extensive memory requirements.

The parallelism modes described herein may be applied to any model architecture that employs attention mechanisms and feedforward computation, regardless of input modality. For multimodal models, the first parallelism mode efficiently handles the increased memory pressure from maintaining cross-modal attention states, while the second parallelism mode's multi-dimensional configuration enables processing of modality-specific expert neural networks.

Example computational pipelines may consist of several stages. First, the attention block might process the input, with each processing unit potentially handling a specific shard of the KV cache. Next, collective communication operations gather and combine the partial outputs. Then, a router determines which expert should process each token. Finally, the feedforward network processes the tokens in the reconfigured parallelism layout, with additional communication operations to potentially finalize and redistribute the outputs.

Implementation of this parallelism approach may involve the configuration of several parameters. These could include the total number of processing units, how the KV cache might be distributed, the tensor parallelism and expert parallelism degrees, and the expert placement strategy. A task scheduler or planner component within the runtime system may manage these configurations based on factors such as latency goals, expected traffic patterns, and service level objectives.

In some example embodiments, this approach provides a systematic way to handle the challenges of decode-time inference in various model types, including large language models. By matching parallelism strategies to the computational characteristics of different model components, example embodiments may achieve efficient utilization of processing resources. This efficiency can translate to improved performance for applications requiring long-context understanding and generation capabilities.

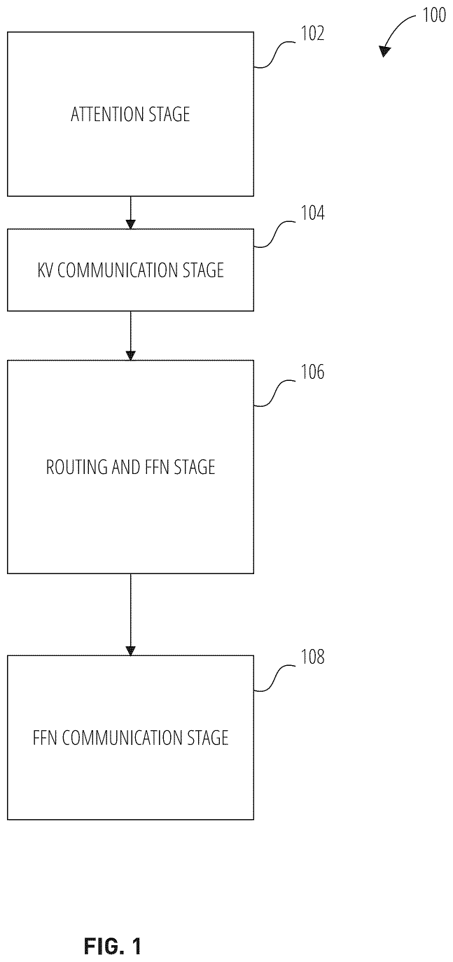

### FIG. 1—INFERENCE PIPELINE—OVERVIEW

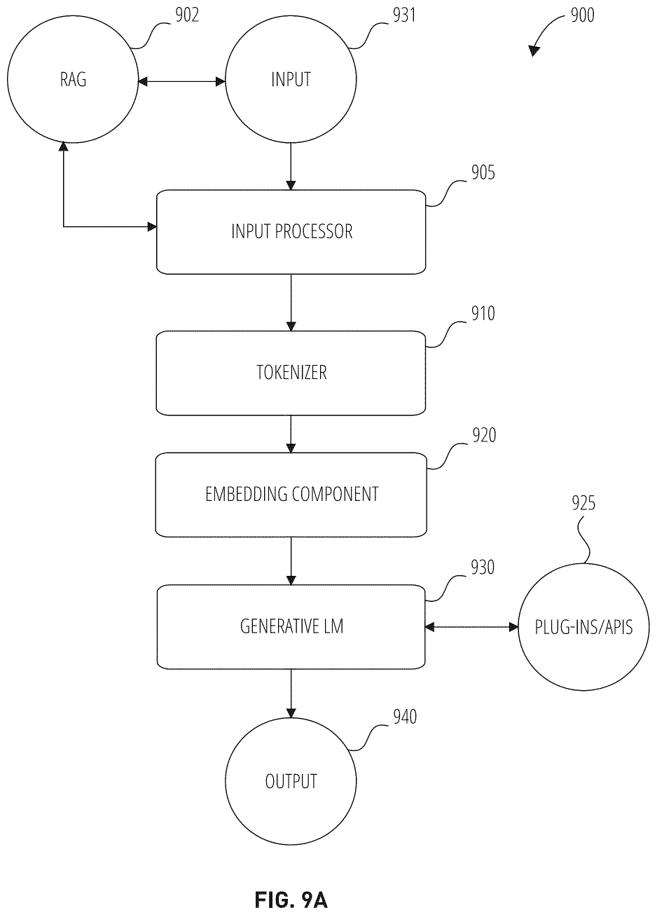

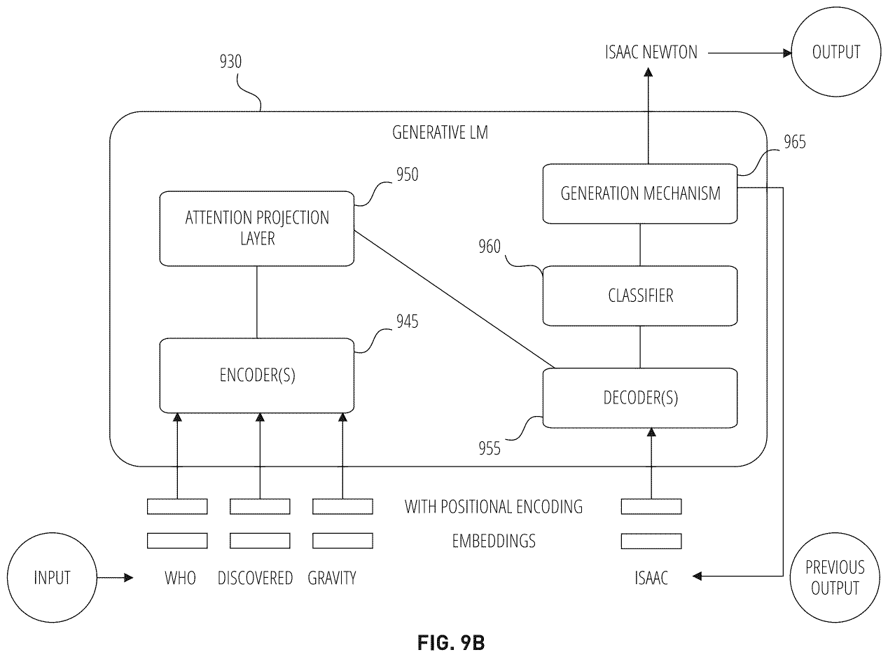

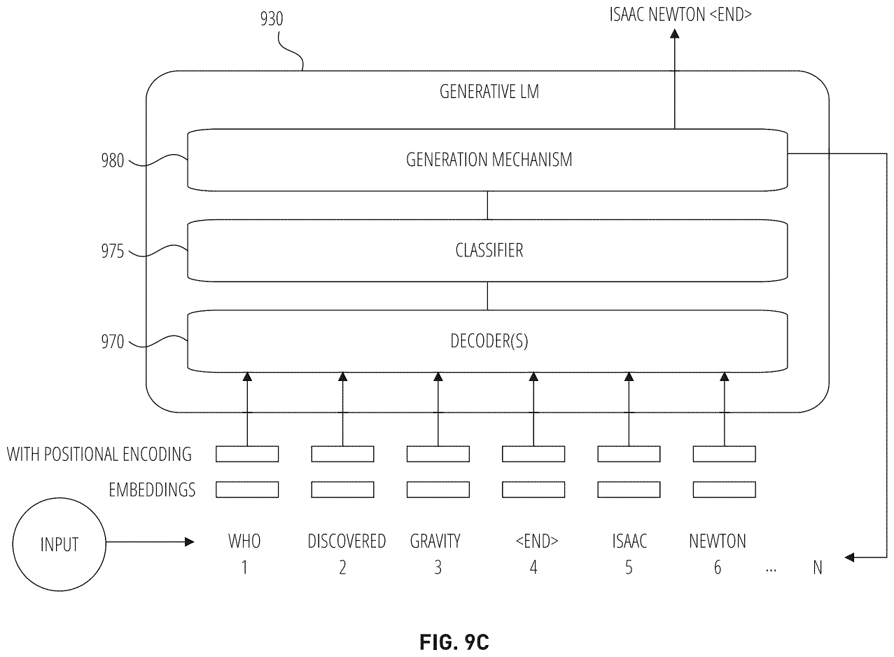

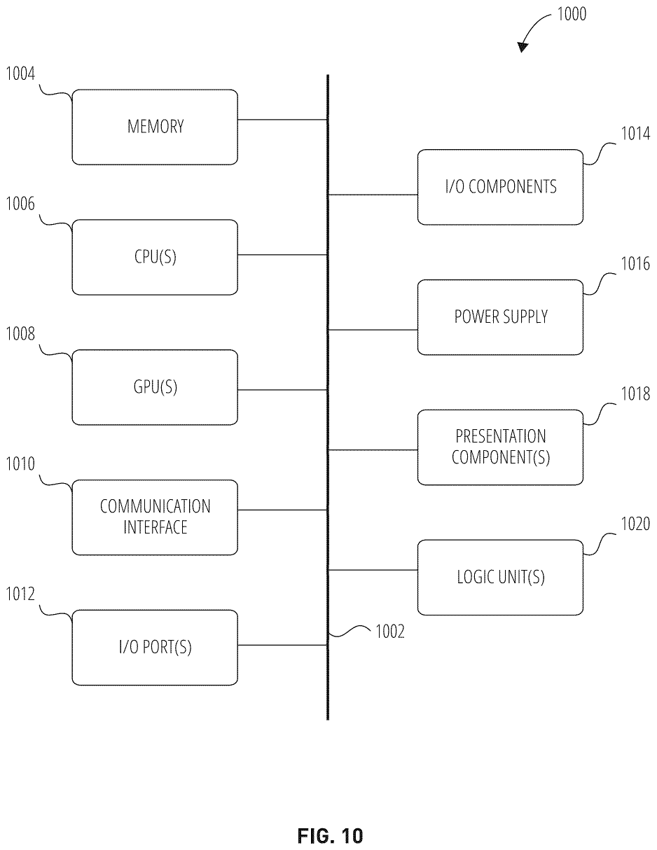

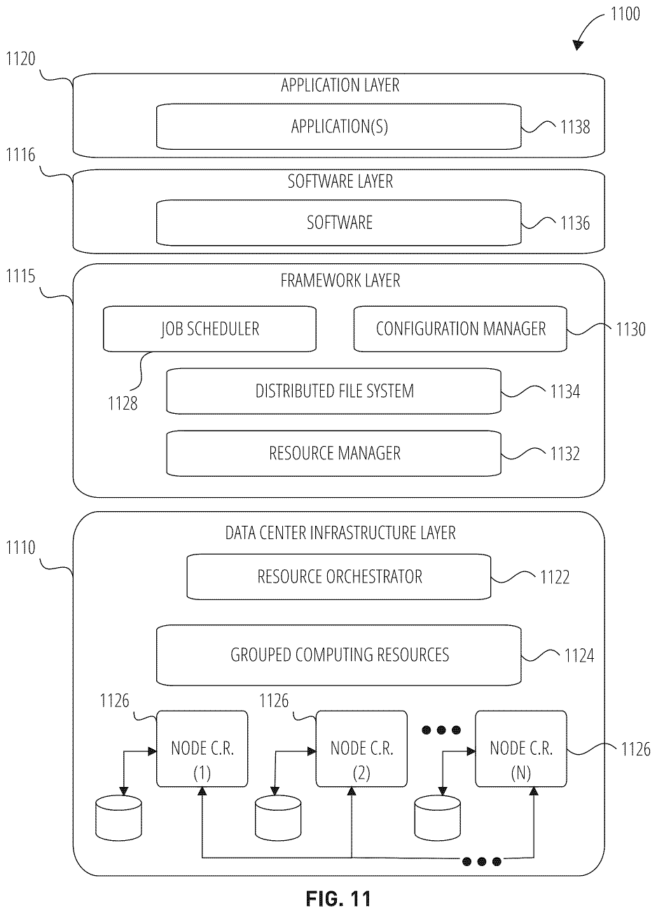

With reference to FIG. 1, an example inference pipeline 100, in accordance with some embodiments of the present disclosure, of a model (e.g., an LLM) is shown. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIG. 9A to FIG. 9C), one or more computing devices or components thereof (e.g., as described in FIG. 10), and/or one or more data centers or components thereof (e.g., as described in FIG. 11).

FIG. 1 is a block diagram illustrating, at a high level, the inference pipeline 100 for processing language model data through sequential computational stages, according to some embodiments, of a dynamic parallelism system. The inference pipeline 100 enables processing of both dense and sparse computational architectures through reconfigurable parallelism modes. An overview of the inference pipeline 100 is provided next, followed by more detailed descriptions with reference to subsequent figures.

The inference pipeline 100 is shown to include an attention stage 102 (or attention computational phase), a KV communication stage 104, a routing and a routing and FFN (Feed Forward Network) stage 106 (or a feedforward computation phase) and a FFN communication stage 108. The attention stage 102 processes input data through distributed computation. In some embodiments, the attention stage 102 may specifically compute key, query, and value projections while maintaining distributed portions of a key-value cache across processing units along the sequence dimension rather than the heads dimension, providing an approach for processing models with reduced key-value heads such as Multi-Query Attention (MQA), Multi-Head Latent Attention (MLA), and Grouped Query Attention (GQA).

The KV communication stage 104 enables data exchange between processing units. In some embodiments, the KV communication stage 104 may implement collective communication operations, including all-gather operations to aggregate partial attention outputs and correction factors, followed by local reduction and correction operations that maintain mathematical equivalence with non-distributed attention computation.

The routing and FFN stage 106 manages token processing through neural networks. In some embodiments, the routing and FFN stage 106 may implement dynamic token routing to specialized expert neural networks in a Mixture-of-Experts architecture, with each expert placed on an expert parallelism slice and tensor-parallelized across processing units according to N=TP×EP, where N represents total processing units, TP represents tensor parallelism degree, and EP represents expert parallelism degree.

The FFN communication stage 108 coordinates data transfer during feedforward computation. In some embodiments, this FFN communication stage 108 may include specific all-reduce operations within each expert's tensor parallelism group to finalize outputs, followed by all-gather operations for regrouping token outputs back to their original GPU/device placement.

The inference pipeline 100 may enable dynamic reconfiguration of processing units between different parallelism modes. In some embodiments, when processing dense models without mixture-of-experts, the inference pipeline 100 can adapt to pure tensor-parallel execution by setting the expert parallelism dimension to one while maintaining the same processing flow and enabling deployment across both dense and sparse model variants using a single software path.

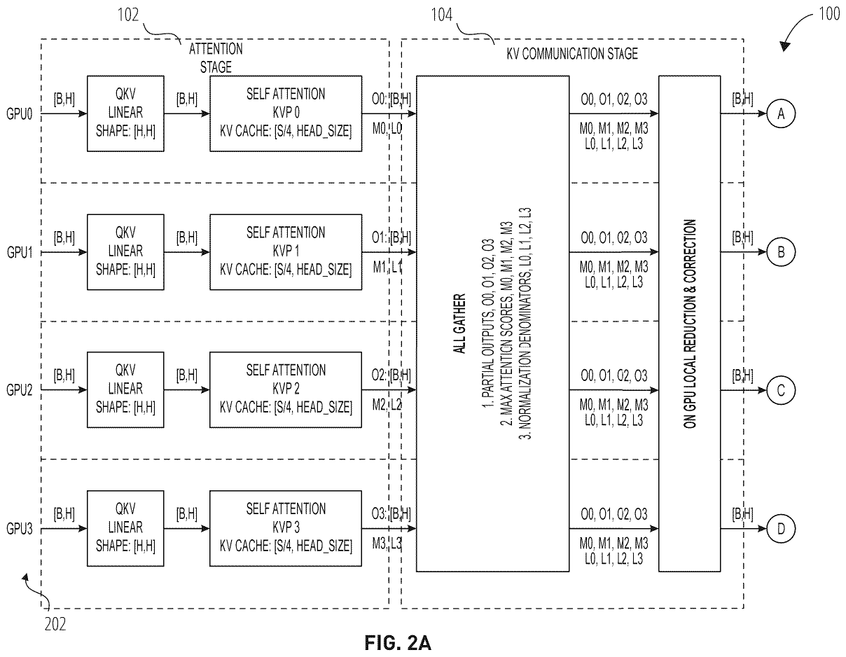

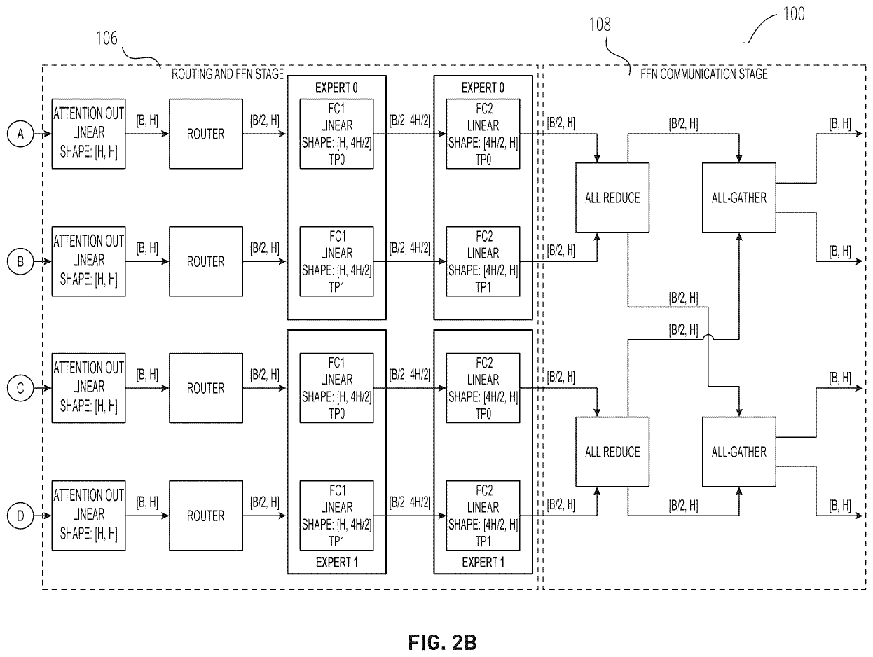

### FIG. 2A AND FIG. 2B—INFERENCE PIPELINE DETAIL

Building upon the high-level inference pipeline 100 shown in FIG. 1, FIG. 2A and FIG. 2B are block diagrams illustrating a technical implementation of parallelism modes for processing language model data through distributed computation stages, according to some embodiments, of a dynamic parallelism system for language model inference.

Referring to FIG. 2A, at the attention stage 102, input data is processed through a set 202 of graphics processing units (GPUs). In some embodiments, each GPU of the GPU set 202 may compute Query-Key-Value (QKV) projections with shape [H, H] and perform self-attention operations on Key-Value (KV) cache portions of size [S/N, Head_Size], where S represents the total sequence length and H represents the head dimension. The key-value cache may be distributed along the sequence dimension rather than the heads dimension, enabling processing of models with reduced key-value heads such as Multi-Query Attention (MQA), Multi-Head Latent Attention (MLA), and Grouped Query Attention (GQA).

During attention computation, the pool of N GPUs may operate uniformly as a unified kernel distributed across the processing units. In this unified kernel mode, the processing units participate collectively in computing key, query, and value projections, attention weights, and outputs without distinguishing between tensor parallelism or expert parallelism roles. This unified kernel approach may enable balanced workload distribution and efficient utilization of available processing resources during the attention computation phase.

At the KV communication stage 104, data exchange is coordinated between processing units. In some embodiments, collective communication operations, including all-gather operations, aggregate partial attention outputs labeled as O0, O1, O2, O3 along with corresponding metadata including maximum attention scores (m0-mN-1) and normalization denominators (L0-LN-1), followed by local reduction and correction operations that maintain mathematical equivalence with non-distributed attention computation.

Referring now to FIG. 2B, at the routing and FFN stage 106, token distribution is managed through neural networks. In some embodiments, routers may implement dynamic token routing to specialized expert neural networks, with each expert tensor-parallelized across two GPUs using Fully Connected layer 1 (FC1) and Fully Connected layer 2 (FC2) linear layers having shapes [H, 4H/2] and [4H/2, H] respectively, where each expert spans Tensor Parallelism (TP) GPUs and experts are sharded along the Expert Parallelism (EP) dimension.

At the FFN communication stage 108, data exchange is coordinated during feedforward computation. In some embodiments, all-reduce operations are performed within each expert's tensor parallelism group to finalize outputs, followed by all-gather operations for regrouping token outputs back to their original GPU/device placement.

The inference pipeline 100 enables processing of both dense and sparse computational architectures through the GPU set 202. In some embodiments, when processing dense models without MoE, the inference pipeline 100 can adapt to pure tensor-parallel execution by setting the expert parallelism dimension to one, while maintaining the same processing flow.

The inference pipeline 100 may implement specific tensor transformations, including [B, H] for input/output tensors and [B/2, H] for expert computations, with batch size B being divided across expert parallel groups. In some embodiments, these transformations may enable distributed parallel processing while maintaining mathematical equivalence with non-distributed computation.

By way of further clarification relating to the collective communications mentioned above, in some embodiments, the collective communication operations exchange specific data between processing units to enable mathematically equivalent distributed computation. During the attention stage 102, an all-gather operation aggregates multiple types of data from each processing unit, for example:
1. Partial attention output tensors (O0-ON-1) computed locally on each GPU;
2. Maximum attention scores (m0-mN-1) for each token's attention distribution; and
3. Normalization denominators (L0-LN-1) for proper SoftMax calculation.

After the all-gather operation is complete, each processing unit contains a complete set of partial outputs and correction factors from other units. The processing units then perform local reduction and correction operations to combine these gathered tensors into mathematically equivalent attention outputs. During the FFN communication stage 108 of the second parallelism mode, the collective communication operations may include, for example:
1. All-reduce operations within each expert's tensor parallelism group to finalize outputs from distributed expert computation; and
2. All-gather operations to regroup token outputs back to their original GPU/device placement after expert processing is complete.

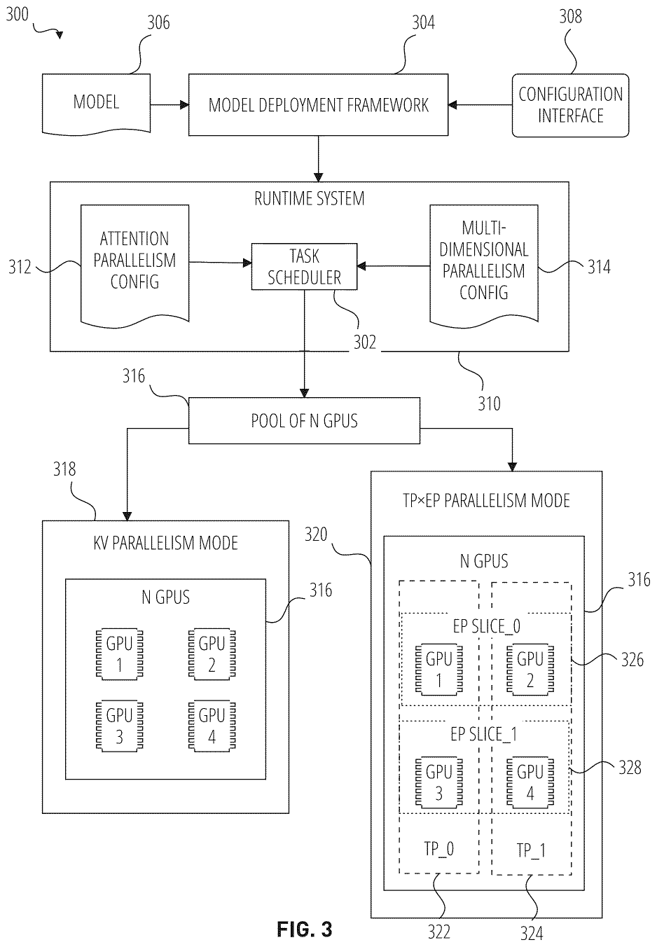

These specific communication patterns seek to reduce data transfer between processing units while maintaining mathematical equivalence with non-distributed computation. The task scheduler 302 (FIG. 3) coordinates these collective operations to enable proper synchronization between processing units during mode transitions.

It should further be noted that, in some embodiments, the FFN communication stage 108 may implement one of multiple communication patterns to exchange data between processing units.

In a first example pattern, the inference pipeline 100 performs, for example:
1. All-reduce operations within each expert's tensor parallelism group to finalize outputs; and
2. All-gather operations to regroup token outputs back to their original GPU/device placement

In a second example pattern, the inference pipeline 100 performs, for example:
1. An all-gather operation across all N GPUs to collect outputs; and
2. Local reduction operations on each GPU to combine the gathered outputs.

These communication patterns provide flexibility in how outputs are combined and redistributed while maintaining mathematical equivalence. The specific pattern used may be selected based on hardware configuration, model architecture, or performance requirements.

### FIG. 3—MODEL INFERENCE SYSTEM

Building upon the high-level inference pipeline 100 shown in FIG. 1, and the technical implementation illustrated in FIG. 2A, FIG. 3 is a block diagram illustrating a model inference system 300 according to some embodiments, that implements the inference pipeline 100 for language model inference.

The model inference system 300 includes a model deployment framework 304 that is responsible for deploying and managing models 306 (e.g., of any one or more of the types mentioned herein). In some embodiments, the model deployment framework 304 may access a model 306, and further receive input from a configuration interface 308 that provides configuration parameters. The configuration parameters are established before inference begins based on workload characteristics, latency goals, and service level agreements. The model deployment framework 304 and configuration interface 308 provide initialization data, based at least partially on the configuration parameters, that the runtime system 310 uses to establish the parallel strategy, creating appropriate data structures distributed across the specified GPUs before processing begins.

The model deployment framework 304 interfaces with a runtime system 310 that coordinates parallel processing operations. In some embodiments, the runtime system 310 accesses configuration parameters for multiple parallelism modes to enable dynamic reconfiguration between these parallelism modes. These parameters are managed by the task scheduler 302, which coordinates the transition between parallelism modes during inference. For example, the task scheduler 302 of the runtime system 310 may receive attention parallelism configuration parameters 312 and multi-dimensional parallelism configuration parameters 314 (e.g., from the model deployment framework 304) as input.

The attention parallelism configuration parameters 312 include several categories of settings. Key-value cache distribution parameters define how the KV cache is distributed across processing units, including sequence dimension sharding specifications and KV cache shard size allocations (e.g., [S/N, Head_Size] where S represents total sequence length and N represents the number of processing units). Communication parameters specify how partial outputs and correction factors are exchanged between processing units, including an all-gather configuration for collecting attention outputs (O0-ON-1) and corresponding metadata (maximum attention scores and normalization denominators). Memory management parameters optimize KV cache growth during sequence processing, ensuring scalable distribution across the processing units without centralized memory bottlenecks.

The multi-dimensional parallelism configuration parameters 314 establish the organization of processing units for feedforward computation. Dimension parameters define tensor parallelism degree (TP) and expert parallelism degree (EP) values that satisfy the mathematical relationship N=TP×EP where N represents the total number of processing units. Expert placement strategy parameters determine how experts are distributed across EP-slices, with each expert's implementation tensor-parallelized across TP GPUs. Routing parameters control how tokens are directed to expert neural networks, including top-k selection values (e.g., k=1 or k=8) and token gathering approaches. Communication parameters configure operations such as all-reduce within expert tensor parallelism groups and all-gather for redistributing token outputs.

In some embodiments, the task scheduler 302 may implement routing-aware resource mapping specifically aligned to the MoE structure and serve as the controller that facilitates both initialization and runtime coordination between parallelism modes using the attention parallelism configuration parameters 312 and the multi-dimensional parallelism configuration parameters 314. The task scheduler 302 may coordinate synchronization between GPUs during mode transitions, ensuring that the GPUs complete their attention computation tasks before transitioning to the second mode.

A pool of N GPUs 316 enables distributed parallel processing through multiple configurations. In an example first parallelism mode, referred to as KV parallelism mode 318, the N GPUs 316 distribute memory and computation load across processing units. In some embodiments, each GPU of the N GPUs 316 maintains a portion of size [S/N, Head_Size] of the total KV cache for sequence length S, providing distributed memory usage and access during long-context decode operations, where S represents the total sequence length that can scale to millions of tokens.

The same pool of N GPUs 316 supports reconfigurable parallel processing through an example second parallelism mode, referred to as TP×EP parallelism mode 320, where the processing units implement a multi-dimensional parallelism strategy. In some embodiments, the GPUs are organized into tensor parallelism slices TP_0 322 and TP_1 324 combined with expert parallelism slices EP slice_0 326 and EP slice_1 328, where each expert may be placed on an EP-slice with its implementation tensor-parallelized across TP GPUs. This transition between modes occurs as a synchronized process after the attention stage 102 is completed and before FFN communication stage 108 begins.

The model inference system 300 coordinates data exchange between parallelism modes through the task scheduler 302. In some embodiments, this coordination may include all-gather operations for attention result collection, all-reduce operations for tensor-parallel expert computation, and all-gather operations for regrouping token outputs. These communication patterns are configured based on the specific parallelism modes and facilitate efficient data transfer while maintaining mathematical equivalence with non-distributed computation.

The model inference system 300 accommodates different computational models through adaptive configuration. In some embodiments, when processing dense models without mixture-of-experts, the expert parallelism dimension may equal one, allowing the inference pipeline 100 to gracefully degrade to pure tensor-parallel execution while maintaining the same processing flow through the task scheduler 302. This enables deployment across both dense and MoE variants using a single software implementation path, providing practical deployment flexibility.

In some embodiments, the model inference system 300 supports micro-batching where multiple batches of requests can be processed simultaneously. When implementing micro-batching, different batches may be processed in different parallelism modes concurrently. For example, while one batch is being processed in the first parallelism mode for attention computation, another batch may simultaneously be processed in the second parallelism mode for feedforward computation. This enables efficient pipelining of multiple work streams while maintaining the benefits of dynamic parallelism reconfiguration for each individual batch.

The task scheduler 302 coordinates the parallel processing of multiple batches, ensuring proper synchronization and resource allocation between batches in different parallelism modes. This micro-batching capability provides additional flexibility in how computational resources are utilized, allowing the system to maintain high throughput when processing multiple inference requests simultaneously while preserving the low-latency benefits of dynamic parallelism reconfiguration within each batch.

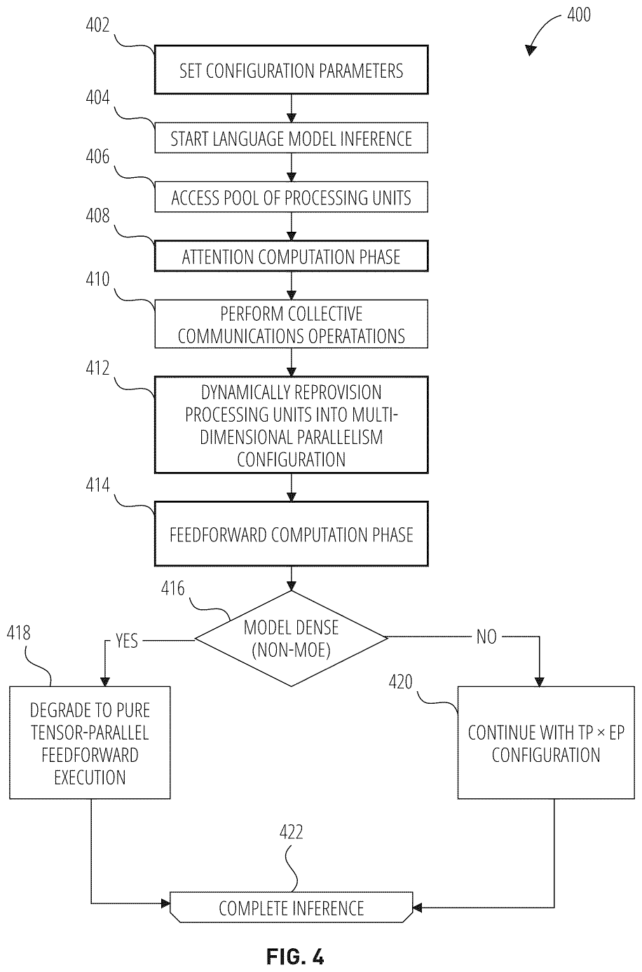

### FIG. 4—DYNAMIC PARALLELISM OVERALL

FIG. 4 is a flowchart illustrating a method 400 for implementing dynamic parallelism in a model inference system 300 that supports an inference pipeline 100 of an LLM, according to some embodiments, for processing both dense and sparse computational architectures.

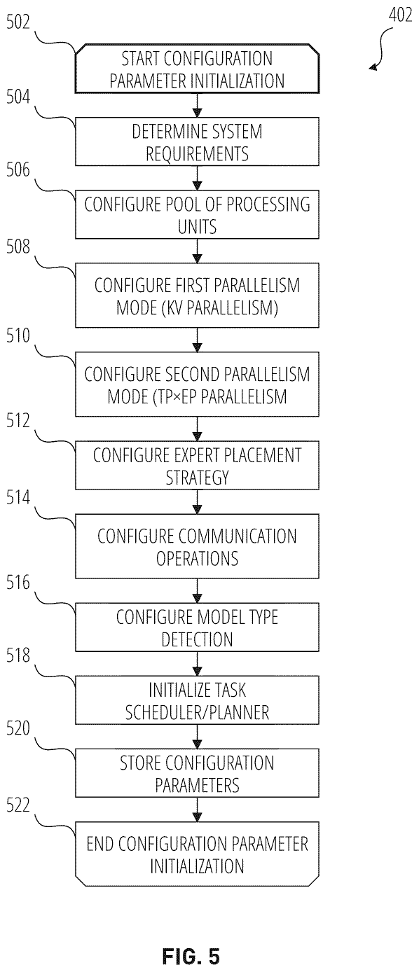

At block 402, the model deployment framework 304 and the configuration interface 308 establish system initialization and configuration parameters. In some embodiments, these parameters may include specifications for distributing key-value cache data across processing units, determining tensor parallelism degrees, and calculating expert parallelism values that can satisfy the mathematical relationship N=TP×EP, where N represents the total number of processing units. Further details regarding this operation are provided below with reference to FIG. 5

At block 404, the runtime system 310 initiates model processing, followed by block 406 where the runtime system 310 accesses computational resources in the form of a pool of N GPUs 316.

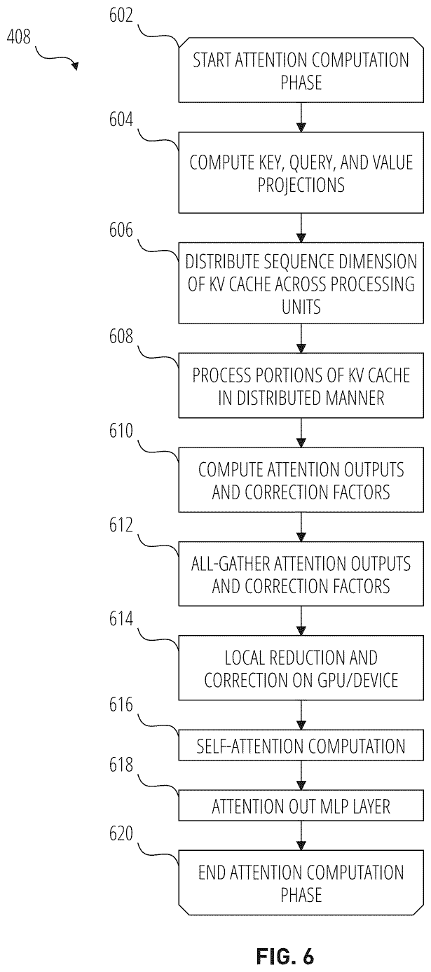

At block 408, the model inference system 300 executes an attention computation phase. In some embodiments, the pool of N GPUs 316 operating in KV parallelism mode 318 may process input data by computing key, query, and value projections while maintaining distributed portions of a key-value cache along the sequence dimension rather than the heads dimension, which can support processing of models with reduced key-value heads. Further details regarding this operation are provided below with reference to FIG. 6.

At block 410, the model inference system 300 performs data synchronization operations. In some embodiments, the task scheduler 302 may implement collective communication operations, including all-gather operations to aggregate partial attention outputs, followed by local reduction and correction steps that aim to maintain mathematical equivalence with non-distributed attention computation.

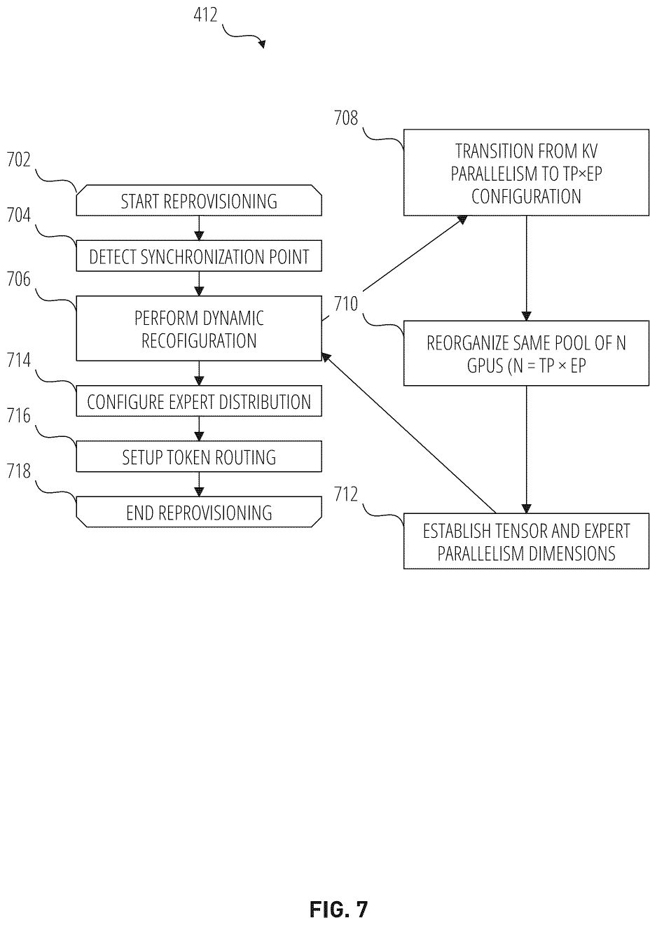

At block 412, the model inference system 300 reconfigures its processing architecture. In some embodiments, the task scheduler 302 may reprovision the pool of N GPUs 316 into a multi-dimensional parallelism configuration organized according to N=TP×EP, where each expert can be placed on an EP-slice with its implementation tensor-parallelized across TP GPUs. Further details regarding this operation are provided below with reference to FIG. 7.

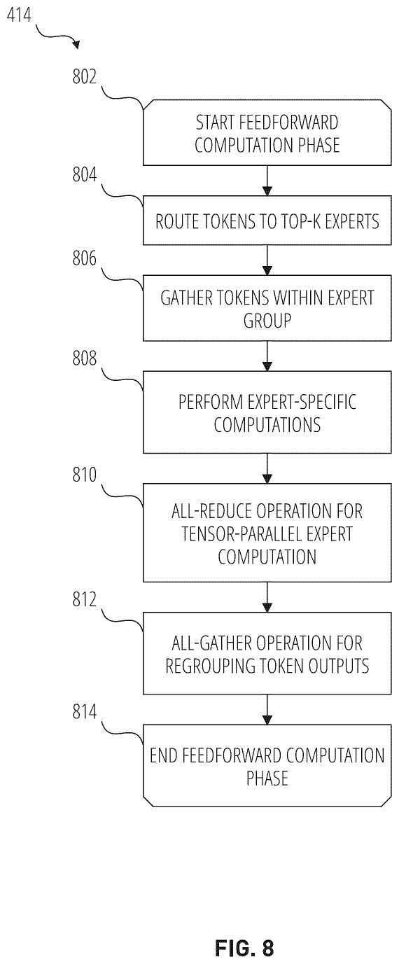

At block 414, the model inference system 300 processes data through neural network components. In some embodiments, the FFN communication stage 108 may involve routing tokens to top-k experts (e.g., k=1 or 2), gathering them within expert groups, and performing expert-specific computations using tensor-parallel processing across allocated GPUs. Further details regarding this operation are provided below with reference to FIG. 8.

At block 416, the runtime system 310 of the model inference system 300 evaluates whether the model architecture, for example, is dense (e.g., non-MoE) or sparse. In some embodiments, this evaluation determines if the model uses a standard dense feedforward network without mixture-of-experts components. If the evaluation determines the model architecture is dense (YES path), the method 400 proceeds to block 418, where the inference pipeline 100 may implement pure tensor-parallel feedforward execution by setting the expert parallelism dimension (EP) to one, effectively collapsing the multi-dimensional parallelism configuration to a single tensor parallelism dimension. If the evaluation determines the model architecture is not dense but rather sparse (e.g., uses a MoE architecture) (NO path), the method 400 continues to block 420, where the inference pipeline 100 maintains the TP×EP configuration to support specialized expert neural networks distributed across the processing units.

At block 422, the method 400 concludes after completing computational phases while aiming to maintain mathematical equivalence with non-distributed computation.

Expanding on the above, in some embodiments, the task scheduler 302 may dynamically switch between the first parallelism mode and the second parallelism mode on a per-step or per-layer basis. The dynamic switching may be determined based on latency goals and computational resource requirements. For example, the task scheduler 302 may evaluate latency targets and available computational resources at each processing step or neural network layer to determine optimal parallelism configuration. This allows fine-grained adaptation of the parallelism strategy throughout model inference to maintain efficiency while meeting performance objectives. The task scheduler 302 coordinates the transitions between modes by ensuring proper synchronization of processing units and managing collective communication operations during each reconfiguration.

Further, some example embodiments may adapt to the multi-dimensional parallelism configuration based on MoE granularity considerations. For fine-grained MoE models, where the expert weights are small, the runtime system 310 may configure pure Expert Parallelism (EP) without tensor parallelism, setting the tensor parallelism dimension to one. For coarse-grained MoE models with larger expert neural networks, the runtime system 310 may maintain both tensor parallelism and expert parallelism dimensions (TP×EP configuration) to balance computational efficiency and communication overhead. This adaptive approach seeks to provide increased resource utilization across different MoE architectures, ranging from models with many tiny experts to those with fewer, computation-heavy experts.

The method 400 can thus enable processing of both dense and sparse model architectures through dynamic reconfiguration of processing resources between different parallelism modes, supporting computational accuracy and performance.

Although the example method 400 depicts a particular sequence of operations, the sequence may be altered without departing from the scope of the present disclosure. For example, some of the operations depicted may be performed in parallel or in a different sequence that does not materially affect the function of the method 400. In some examples, different components of an example device or system that implements the method 400 may perform functions at substantially the same time or in a specific sequence.

### FIG. 5—CONFIGURATION PARAMETER INITIALIZATION PROCESS

FIG. 5 is a flowchart illustrating a configuration parameter initialization process, according to some embodiments, at block 402 of FIG. 4 that enables dynamic parallelism in language model inference.

At block 402, the model deployment framework 304 performs configuration parameter initialization for implementing dynamic parallelism. This initialization process establishes the foundation for the dynamic reconfiguration capabilities described in FIG. 3, where processing units transition between KV parallelism mode 318 and TP×EP parallelism mode 320.

At block 502, a configuration procedure is initiated to begin parameter setup. In some embodiments, a configuration interface 308 may initiate this configuration parameter initialization process using initialization data received from the model deployment framework 304.

At block 504, system requirements are evaluated to determine operational constraints. In some embodiments, a runtime system 310 may analyze workload characteristics such as expected sequence lengths and batch sizes, memory constraints for KV cache distribution, and latency goals that inform resource allocation.

At block 506, processing resources are pooled for distributed computation. In some embodiments, the runtime system 310 may configure a set or pool of processing units by establishing access to N processing units that can be dynamically reprovisioned between different parallelism modes, as represented for example by the pool of N GPUs 316 shown in FIG. 3.

At block 508, a first computational parallelism approach is configured for attention processing. In some embodiments, a task scheduler 302 may configure a first parallelism mode for key-value (KV) parallelism using attention parallelism configuration parameters 312, specifying how the KV cache will be distributed across processing units along the sequence dimension.

At block 510, a second computational parallelism approach is configured for feedforward processing. In some embodiments, the task scheduler 302 may configure a second parallelism mode using multi-dimensional parallelism configuration parameters 314 to organize processing units according to N=TP×EP.

At block 512, an expert distribution strategy is established. In some embodiments, the task scheduler 302 may configure an expert placement strategy that determines how experts are placed on EP-slices and tensor-parallelized across TP GPUs.

At block 514, data exchange protocols are configured between processing units. In some embodiments, the runtime system 310 may configure communication operations, including all-gather, all-reduce, and all-to-all operations, using collective communication parameters.

At block 516, model architecture detection capabilities are configured. In some embodiments, the runtime system 310 may configure model type detection using model architecture parameters to determine whether a model uses a dense or MoE architecture.

At block 518, a workload management system is initialized. In some embodiments, the runtime system 310 may initialize a task scheduler that implements routing-aware resource mapping and coordinates synchronization between GPUs using the configuration parameters.

At block 520, configuration settings are preserved for subsequent operations. In some embodiments, the configuration interface 308 may store the established configuration parameters in memory for reference during inference operations.

At block 522, the configuration parameter initialization process concludes, with components configured for the dynamic parallelism operations detailed in subsequent figures.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

### FIG. 6-ATTENTION COMPUTATION PHASE

FIG. 6 is a flowchart illustrating an attention computation phase (e.g., attention stage 102), according to some embodiments, that occurs at block 408 of the method 400, for processing language model data through distributed computation stages.

At block 602, the task scheduler 302 initiates an attention computation phase. In some embodiments, this phase begins by coordinating the pool of N GPUs 316 operating in KV parallelism mode 318 to prepare for distributed processing of attention operations.

At block 604, the model inference system 300 performs projection computations. In some embodiments, the pool of N GPUs 316 computes key, query, and value projections with shape [H, H], where H represents the head dimension, processing input data of shape [B, H], where B represents the batch size.

At block 606, the model inference system 300 implements memory management approaches. In some embodiments, the task scheduler 302 distributes a sequence dimension of a key-value (KV) cache across the pool of N GPUs 316, with each GPU maintaining a portion of size [S/N, Head_Size] of the total KV cache shards.

At block 608, the model inference system 300 executes parallel cache processing. Here, each GPU may perform self-attention operations on an assigned KV cache portion in parallel, which can help reduce centralized memory access patterns.

At block 610, the model inference system 300 generates attention computations. In some embodiments, each GPU of the N GPUs 316 computes partial attention outputs (O0-ON-1) along with corresponding metadata, including maximum attention scores (m0-mN-1) and normalization denominators (L0-LN-1).

At block 612, the model inference system 300 performs data aggregation. In some embodiments, an all-gather operation collects outputs of shape [B, H] from each processing unit to support subsequent reduction and correction operations.

At block 614, the model inference system 300 executes optimization operations, which may involve each GPU of the N GPUs 316 performing reduction and correction operations following a Flash Decoding methodology to maintain consistency with non-distributed attention computation. In some embodiments, the Flash Decoding methodology is adapted for distributed processing across multiple GPUs rather than being limited to a single GPU. When implementing Flash Decoding in a distributed environment, each GPU performs local attention computation only on its assigned shard of the KV cache, reducing or eliminating the need for cross-GPU communication during the primary attention calculation phase. After local attention computation, the inference pipeline 100 exchanges information across GPUs, including for example:
1. Partial attention outputs that are calculated locally on each GPU;
2. Maximum attention scores (referred to as “max values”) for each token's attention distribution; and
3. Normalization denominators that are required for the mathematically correct SoftMax calculation.

Once this information is exchanged through an all-gather operation, each GPU can independently apply a correction operation to its local computations, so that the final result is mathematically equivalent to performing a full SoftMax operation across the entire non-sharded attention matrix. This approach may reduce communication overhead by exchanging only the minimal information at the end of the self-attention process, rather than requiring intermediate data exchange during attention computation.

This distributed implementation of Flash Decoding may provide technical advantages, including, for example:
1. Enables processing of longer sequences by distributing the KV cache memory requirements;
2. Maintains mathematical equivalence to traditional attention computation;
3. Reduces inter-GPU communication by exchanging data at specific synchronization points; and
4. Scales efficiently with increasing sequence length and number of GPUs.

At block 616, the model inference system 300 processes self-attention calculations. In some embodiments, each GPU of the N GPUs 316 generates contextualized representations of shape [B, H] using the combined and corrected outputs.

At block 618, the model inference system 300 performs output transformation. In some embodiments, each GPU of the N GPUs 316 processes the attention outputs through an attention output MLP layer with shape [H, H] to prepare for subsequent processing stages.

At block 620, the task scheduler 302 manages phase completion. In some embodiments, this involves coordinating the transition from attention computation to subsequent processing stages.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

### FIG. 7—DYNAMIC REPROVISIONING PROCESS

FIG. 7 is a flowchart illustrating a dynamic reprovisioning process, according to some embodiments, that occurs at block 412 of the method 400, of a model inference system 300 for processing language model data through distributed computation stages.

At block 702, the model inference system 300 initiates a resource management process. In some embodiments, the task scheduler 302 begins reprovisioning by accessing configuration parameters (e.g., attention parallelism configuration parameters 312 and multi-dimensional parallelism configuration parameters 314 received from the configuration interface 308 and the model deployment framework 304) to prepare for transitioning between parallelism modes.

At block 704, the model inference system 300 performs synchronization monitoring. In some embodiments, the task scheduler 302 detects that all GPUs in the pool of N GPUs 316 have completed their attention computation tasks and committed their partial outputs to the all-gather operation.

At block 706, the model inference system 300 executes a configuration transformation. In some embodiments, the runtime system 310 prepares the pool of N GPUs 316 for transition between the KV parallelism mode 318 and the TP×EP parallelism mode 320. This reconfiguring is performed at block 708, block 710, and block 712, which reflect sub-operations of block 706.

At block 708, the model inference system 300 implements parallelism mode conversion. In some embodiments, the task scheduler 302 executes the transition from KV parallelism to TP×EP configuration using the multi-dimensional parallelism configuration parameters 314.

At block 710, the model inference system 300 performs resource redistribution. In some embodiments, the runtime system 310 reorganizes the pool of N GPUs 316 according to the mathematical relationship N=TP×EP, where TP represents the tensor parallelism degree and EP represents the expert parallelism degree.

At block 712, the model inference system 300 establishes computational dimensions. In some embodiments, the task scheduler 302 configures tensor and expert parallelism dimensions using both attention parallelism configuration parameters 312 and multi-dimensional parallelism configuration parameters 314.

At block 714, the model inference system 300 implements expert allocation. In some embodiments, the runtime system 310 configures the distribution of experts across EP slice_0 326 and EP slice_1 328, with each expert's implementation tensor-parallelized across TP_0 322 and TP_1 324.

At block 716, the model inference system 300 configures workload distribution. For example, the task scheduler 302 establishes expert distribution parameters to support parallel processing capabilities across the available processing units.

At block 718, the model inference system 300 establishes data routing protocols. Here, in some embodiments, the runtime system 310 configures how tokens can be directed to their top-k selected experts based on routing scores and expert availability.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

### FIG. 8—FEEDFORWARD COMPUTATION PHASE

FIG. 8 is a flowchart illustrating a feedforward computation phase, according to some embodiments, that occurs at block 414 of the method 400, performed by the model inference system 300 for processing language model data through distributed computation stages.

At block 802, the model inference system 300 initiates computational resource allocation. For example, the runtime system 310 may begin the feedforward computation phase using the pool of N GPUs 316 that have been configured in TP×EP parallelism mode 320, following the mathematical relationship N=TP×EP.

At block 804, the model inference system 300 implements token distribution mechanisms. In some embodiments, the task scheduler 302 routes tokens of shape [B, H] to their selected experts based on routing scores computed during the dynamic reprovisioning process, where k typically equals 1 or 2 experts per token.

At block 806, the model inference system 300 performs data organization operations. For example, the runtime system 310 gathers tokens within their assigned expert groups according to the TP×EP configuration, where experts are distributed across EP slice_0 326 and EP slice_1 328.

At block 808, the model inference system 300 executes parallel processing operations. In some embodiments, each expert's implementation may be tensor-parallelized across TP_0322 and TP_1 324 using FC1 and FC2 linear layers with shapes [H, 4H/2] and [4H/2, H], respectively.

At block 810, the model inference system 300 performs result aggregation. Here, the task scheduler 302, in some example embodiments, executes an all-reduce operation to combine partial results from tensor-parallel expert computation within each expert's tensor parallelism group.

At block 812, the model inference system 300 implements output reorganization. In some embodiments, the runtime system 310 performs an all-gather operation to regroup token outputs of shape [B, H] back to their original GPU/device placement.

At block 814, the model inference system 300 concludes processing operations. In some embodiments, this marks the completion of expert-specific computations and collective communication operations before proceeding to complete inference at block 422 of FIG. 4.

Although the example method depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

### FIG. 9A-FIG. 9C: EXAMPLE LANGUAGE MODELS

In at least some embodiments, the model deployment framework 304 may implement various types of language models, such as large language models (LLMs), vision language models (VLMs), multi-modal language models (MMLMs), and/or other types of generative artificial intelligence (AI). These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries processed by the runtime system 310. These language models may be considered “large,” in embodiments, based on the models being trained on massive datasets and having architectures with large number of learnable network parameters (weights and biases)—such as millions or billions of parameters. The model deployment framework 304 may implement the LLMs/VLMs/MMLMs/etc. for summarizing textual data, analyzing and extracting insights from data (e.g., textual, image, video, etc.), and generating new text/image/video/etc. in user-specified styles, tones, and/or formats. The model deployment framework 304 may configure the LLMs/VLMs/MMLMs/etc. exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented by the model deployment framework 304 to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not need task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to access or use, or capable of accessing or using, one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires or benefits from a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc.), multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models, e.g., language models with different architectures and language models trained on different (e.g., updated) corpora of data, may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two or more prompts provided to at least one language model may be further processed, e.g., aggregated, compared or filtered against, or used to determine (and provide) a consensus response. In one or more embodiments, the output from one language model—or version, instance, or agent—may be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 9A is a block diagram of an example generative language model (LM) system, generative LM system 900, suitable for use in implementing at least some embodiments of the present disclosure. In the example illustrated in FIG. 9A, the generative LM system 900 includes a retrieval augmented generation (RAG) component 902, an input processor 905, a tokenizer 910, an embedding component 920, plug-ins/APIs 925, and a generative LM 930 (which may include an LLM, a VLM, a multi-modal LM, etc.).

At a high level, the input processor 905 may receive an input 931 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 930 (e.g., LLM/VLM/MMLM/etc.). In some embodiments, the input 931 includes plain text in the form of one or more sentences, paragraphs, and/or documents. Additionally or alternatively, the input 931 may include numerical sequences, precomputed embeddings (e.g., word or sentence embeddings), and/or structured data (e.g., in tabular formats, JSON, or XML). In some implementations in which the generative LM 930 is capable of processing multi-modal inputs, the input 931 may combine text (or may omit text) with image data, audio data, video data, design data, USD data, and/or other types of input data, such as but not limited to those described herein. Taking raw input text as an example, the input processor 905 may prepare raw input text in various ways. For example, the input processor 905 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to enable consistency. These are just a few examples, and other types of input processing may be applied.

In some embodiments, a RAG component 902 (which may include one or more RAG models, and/or may be performed using the generative LM 930 itself) may be used to retrieve additional information to be used as part of the input 931 or prompt. RAG may be used to enhance the input to the LLM/VLM/MMLM/etc. with external knowledge, so that answers to specific questions or queries or requests are more relevant—such as in a case where specific knowledge is involved. The RAG component 902 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 931 may be generated using the query or input to the model (e.g., a question, a request, etc.) in addition to data retrieved using the RAG component 902. In some embodiments, the input processor 905 may analyze the input 931 and communicate with the RAG component 902 (or the RAG component 902 may be part of the input processor 905, in embodiments) in order to identify relevant text and/or other data to provide to the generative LM 930 as additional context or sources of information from which to identify the response, answer, or output 940, generally. For example, where the 931 indicates that the user is interested in a desired tire pressure for a particular make and model of vehicle, the RAG component 902 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 902 may retrieve a prior stored conversation history—or at least a summary thereof—and include the prior conversation history along with the current ask/request as part of the input 931 to the generative LM 930.

The RAG component 902 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 902, and the embeddings of the chunks along with the embeddings of the query may be compared to identify the most similar/related embeddings to the query, which may be supplied to the generative LM 930 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 902 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 910 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to a tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 931 includes image data/video data/etc., the input processor 905 may resize the data to a standard size compatible with the format of a corresponding input channel and/or may normalize pixel values to a common range (e.g., 0 to 1) to enable a consistent representation, and the embedding component 920 may encode the image data using any known technique (e.g., using one or more convolutional neural networks (CNNs) to extract visual features). In some implementations in which the input 931 includes audio data, the input processor 905 may resample an audio file to a consistent sampling rate for uniform processing, and the embedding component 920 may use any known technique to extract and encode audio features-such as in the form of a spectrogram (e.g., a mel-spectrogram). In some implementations in which the input 931 includes video data, the input processor 905 may extract frames or apply resizing to extracted frames, and the embedding component 920 may extract features such as optical flow embeddings or video embeddings and/or may encode temporal information or sequences of frames. In some implementations in which the input 931 includes multi-modal data, the embedding component 920 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 930 and/or other components of the generative LM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying nonlinear transformations to the input representations and extracting higher-level features. Some non-limiting example architectures include transformers (e.g., encoder-decoder, decoder only, multi-modal), fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 931 to the generative LM 930, and the generative LM 930 may process the encoded representation of the input 931 to generate an output 940, which may include responsive text and/or other types of data.

As described herein, in some embodiments, the generative LM 930 may be configured to access or use—or capable of accessing or using—plug-ins/APIs 925 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 902) to access one or more plug-ins/APIs 925 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 925 to the plug-in/API 925, the plug-in/API 925 may process the information and return an answer to the generative LM 930, and the generative LM 930 may use the response to generate the output 940. This process may be repeated—e.g., recursively—for any number of iterations and using any number of plug-ins/APIs 925 until an output 940 that addresses each ask/question/request/process/operation/etc. from the input 931 can be generated. As such, the model(s) may not only rely on its own knowledge from training on a large dataset(s) and/or from data retrieved using the RAG component 902, but also on the expertise or optimized nature of one or more external resources-such as the plug-ins/APIs 925.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 9A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 945 of the generative LM 930.

In an example implementation, the encoder(s) 945 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, and a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 950 may convert the context vector into attention vectors (keys and values) for the decoder(s) 955.

In an example implementation, the decoder(s) 955 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 945, in an example transformer architecture, each token (e.g., word) flows through a separate path in the decoder(s) 955. During a first pass, the decoder(s) 955, a classifier 960, and a generation mechanism 965 may generate a first token, and the generation mechanism 965 may apply the generated token as an input during a second pass. The process may repeat in a loop, successively generating and adding tokens (e.g., words) to the output from the preceding pass and applying the token embeddings of the composite sequence with positional encodings as an input to the decoder(s) 955 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the SoftMax operation. In an example implementation, the encoder-decoder attention layer operates similarly to the (e.g., multi-headed) self-attention in the encoder(s) 945, except that it creates its queries from the layer below it and takes the keys and values (e.g., matrix) from the output of the encoder(s) 945.

As such, the decoder(s) 955 may output some decoded (e.g., vector) representation of the input being applied during a particular pass. The classifier 960 may include a multi-class classifier comprising one or more neural network layers that project the decoded (e.g., vector) representation into a corresponding dimensionality (e.g., one dimension for each supported word or token in the output vocabulary) and a SoftMax operation that converts logits to probabilities. As such, the generation mechanism 965 may select or sample a word or token based on a corresponding predicted probability (e.g., select the word with the highest predicted probability) and append it to the output from a previous pass, generating each word or token sequentially. The generation mechanism 965 may repeat the process, triggering successive decoder inputs and corresponding predictions until selecting or sampling a symbol or token that represents the end of the response, at which point the generation mechanism 965 may output the generated response.

FIG. 9C is a block diagram of an example implementation in which the generative LM 930 includes a decoder-only transformer architecture. For example, the decoder(s) 970 of FIG. 9C may operate similarly as the decoder(s) 955 of FIG. 9B except each of the decoder(s) 970 of FIG. 9C omits the encoder-decoder self-attention layer (since there is no encoder in this implementation). As such, the decoder(s) 970 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 970. As with the decoder(s) 955 of FIG. 9B, each token (e.g., word) may flow through a separate path in the decoder(s) 970, and the decoder(s) 970, a classifier 975, and a generation mechanism 980 may use auto-regression to sequentially generate one token at a time until predicting a symbol or token that represents the end of the response. The classifier 975 and the generation mechanism 980 may operate similarly as the classifier 960 and the generation mechanism 965 of FIG. 9B, with the generation mechanism 980 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### FIG. 10: EXAMPLE COMPUTING DEVICE

FIG. 10 is a block diagram of an example computing device 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output (I/O) components 1014, a power supply 1016, one or more presentation components 1018 (e.g., display(s)), and one or more logic units 1020. In at least one embodiment, the computing device 1000 may comprise one or more virtual machines (VMs), and/or any of the components thereof may comprise virtual components (e.g., virtual hardware components). For non-limiting examples, one or more of the GPU(s) 1008 may comprise one or more vGPUs, one or more of the CPU(s) 1006 may comprise one or more vCPUs, and/or one or more of the logic unit(s) 1020 may comprise one or more virtual logic units. As such, a computing device 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPU(s) 1008, the CPU(s) 1006, and/or other components). As such, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU(s) 1006 may be directly connected to the memory 1004. Further, the CPU(s) 1006 may be directly connected to the GPU(s) 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPU(s) 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for general-purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic unit(s) 1020 may be part of and/or integrated in one or more of the CPU(s) 1006 and/or the GPU(s) 1008 and/or one or more of the logic unit(s) 1020 may be discrete components or otherwise external to the CPU(s) 1006 and/or the GPU(s) 1008. In embodiments, one or more of the logic unit(s) 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, including wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008.

The I/O port(s) 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may include one or more depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertial measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### FIG. 11: EXAMPLE DATA CENTER

FIG. 11 illustrates an example data center 1100 that may be used in at least one embodiment of the present disclosure. The data center 1100 may include a data center infrastructure layer 1110, a framework layer 1115, a software layer 1116, and/or an application layer 1120.

As shown in FIG. 11, the data center infrastructure layer 1110 may include a resource orchestrator 1122, grouped computing resources 1124, and node computing resources 1126 (“node C.R.s”), shown as (1)-(N), where “N” represents any whole, positive integer. In at least one embodiment, node computing resources 1126 may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more nodes from among node computing resources 1126 may correspond to a server having one or more of the above-mentioned computing resources. In addition, in some embodiments, the node computing resources 1126 may include one or more virtual components, such as vGPUs, vCPUs, and/or the like, and/or one or more of the node computing resources 1126 may correspond to a virtual machine (VM).

In at least one embodiment, grouped computing resources 1124 may include separate groupings of node computing resources 1126 housed within one or more racks (not shown), or many racks housed in data centers at various geographical locations (also not shown). Separate groupings of node computing resources 1126 within grouped computing resources 1124 may include grouped compute, network, memory or storage resources that may be configured or allocated to support one or more workloads. In at least one embodiment, several node computing resources 1126 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1122 may configure or otherwise control one or more node computing resources 1126 and/or grouped computing resources 1124. In at least one embodiment, the resource orchestrator 1122 may include a software design infrastructure (SDI) management entity for the data center 1100. The resource orchestrator 1122 may include hardware, software, or some combination thereof.

In at least one embodiment, as shown in FIG. 11, the framework layer 1115 may include a job scheduler 1128, a configuration manager 1130, a resource manager 1132, and/or a distributed file system 1134. The framework layer 1115 may include a framework to support software 1136 of the software layer 1116 and/or one or more application(s) 1138 of the application layer 1120. The software 1136 or application(s) 1138 may respectively include web-based service software or applications, such as those provided by Amazon Web Services, Google Cloud and Microsoft Azure. The framework layer 1115 may be, but is not limited to, a type of free and open-source software web application framework such as Apache Spark™ (hereinafter “Spark”) that may use the distributed file system 1134 for large-scale data processing (e.g., “big data”). In at least one embodiment, the job scheduler 1128 may include a Spark driver to facilitate scheduling of workloads supported by various layers of data center 1100. The configuration manager 1130 may be capable of configuring different layers such as the software layer 1116 and framework layer 1115 including Spark and the distributed file system 1134 for supporting large-scale data processing. The resource manager 1132 may be capable of managing clustered or grouped computing resources mapped to or allocated for support of the distributed file system 1134 and job scheduler 1128. In at least one embodiment, clustered or grouped computing resources may include the grouped computing resources 1124 at the data center infrastructure layer 1110. The resource manager 1132 may coordinate with the resource orchestrator 1122 to manage these mapped or allocated computing resources.

In at least one embodiment, the software 1136 included in the software layer 1116 may include software used by at least portions of the node computing resources 1126, grouped computing resources 1124, and/or distributed file system 1134 of the framework layer 1115. One or more types of software may include, but are not limited to, Internet web page search software, e-mail virus scan software, database software, and streaming video content software.

In at least one embodiment, the application(s) 1138 included in the application layer 1120 may include one or more types of applications used by at least portions of the node computing resources 1126, grouped computing resources 1124, and/or distributed file system 1134 of the framework layer 1115. One or more types of application(s) 1138 may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of the configuration manager 1130, resource manager 1132, and resource orchestrator 1122 may implement any number and type of self-modifying actions based on any amount and type of data acquired in any technically feasible fashion. Self-modifying actions may relieve a data center operator of the data center 1100 from making possibly bad configuration decisions and possibly avoiding underutilized and/or poor performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### CONCLUSION

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medical systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another or may be combined in various ways. All possible combinations and sub-combinations are intended to fall within the scope of this disclosure. In addition, certain method or process blocks, or operations may be omitted in some implementations.

The term “operation” is used to refer to elements in the drawings of this disclosure for ease of reference and it will be appreciated that each “operation” may identify one or more operations, processes, actions, or steps, and may be performed by one or multiple components.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE CLAUSES

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is one or more processors comprising processing circuitry to perform operations comprising: reconfiguring a pool of processing units between a first parallelism mode for attention computation and a second parallelism mode for feedforward computation in a language model inference system, wherein the first parallelism mode distributes contextual memory data across the pool of processing units, and the second parallelism mode reorganizes the pool of processing units into a multi-dimensional parallelism configuration having a tensor parallelism dimension and a sparse computation dimension for processing tokens through a plurality of neural networks in a sparse computation architecture.

In Example 2, the subject matter of Example 1, wherein the first parallelism mode comprises key-value (KV) parallelism in which the pool of processing units participates in computing key, query, and value projections, and attention values.

In Example 3, the subject matter of any one or more of Examples 1-2, wherein the sparse computation architecture comprises a Mixture-of-Experts architecture, and wherein the sparse computation dimension comprises an expert parallelism dimension.

In Example 4, the subject matter of any one or more of Examples 1-3, wherein the operations further comprise performing collective communication operations to facilitate transition between the first parallelism mode and the second parallelism mode, the collective communication operations comprising at least one of: an all-gather operation, an all-reduce operation, or an all-to-all operation.

In Example 5, the subject matter of any one or more of Examples 1-4, wherein the operations further comprise routing tokens to a subset of the plurality of neural networks in the sparse computation architecture based on token content.

In Example 6, the subject matter of any one or more of Examples 1-5, wherein the second parallelism mode comprises processing sparse activation patterns where a subset of the neural network is activated for each input token.

In Example 7, the subject matter of any one or more of Examples 1-6, wherein, based on the sparse computation dimension equaling one, the operations further comprise collapsing the second parallelism mode to tensor parallelism.

In Example 8, the subject matter of any one or more of Examples 1-7, wherein the operations further comprise dynamically reconfiguring the pool of processing units on at least one of a per-step or per-layer basis.

In Example 9, the subject matter of any one or more of Examples 1-8, wherein, in the second parallelism mode, feedforward neural networks are distributed using a Tensor Parallelism (TP)×Expert Parallelism (EP) configuration.

In Example 10, the subject matter of any one or more of Examples 1-9, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

In Example 11, the subject matter is a method for accelerating inference in language models, comprising: configuring a pool of processing units in a first parallelism mode for attention computation, the first parallelism mode distributing contextual memory data across the pool of processing units; performing attention computation operations using the pool of processing units to process the contextual memory data; reconfiguring the pool of processing units from the first parallelism mode to a second parallelism mode for feedforward computation after completing the attention computation operations, the second parallelism mode reconfiguring the pool of processing units into a multi-dimensional parallelism configuration having a tensor parallelism dimension and a sparse computation dimension; and executing feedforward neural network operations using the reconfigured pool of processing units to generate output token probabilities for autoregressive token generation.

In Example 12, the subject matter of Example 11, wherein the first parallelism mode comprises key-value (KV) parallelism that distributes a sequence dimension of a KV cache across the pool of processing units, and wherein performing the attention computation operations comprises: computing key, query, and value projections for an input token; calculating attention weights between the input token and the KV cache; and producing a context-aware representation of the input token.

In Example 13, the subject matter of any one or more of Examples 11-12, further comprising performing collective communication operations during transition between the first parallelism mode and the second parallelism mode, the collective communication operations comprising: executing an all-gather operation to aggregate partial attention outputs from each processing unit in the pool of processing units; performing a local reduction to combine the aggregated partial attention outputs into combined outputs; and applying a correction operation to the combined outputs to maintain mathematical equivalence with non-distributed attention computation.

In Example 14, the subject matter of any one or more of Examples 11-13, wherein reconfiguring the pool of processing units comprises organizing the processing units according to a mathematical relationship defined by N=TP×EP, where N represents a total number of processing units, TP represents a tensor parallelism degree, and EP represents an expert parallelism degree.

In Example 15, the subject matter of any one or more of Examples 11-14, further comprising: determining routing scores for tokens relative to available experts in a sparse computation architecture; selecting a predetermined number k of highest-scoring experts for each token, wherein k is a positive integer; and routing each token to its selected expert neural networks for processing in the second parallelism mode.

In Example 16, the subject matter of any one or more of Examples 11-15, wherein the sparse computation dimension is for processing tokens through expert neural networks in a Mixture-of-Experts architecture, and the method further comprises: placing each expert on an expert parallelism slice; and tensor-parallelizing each expert's implementation across a subset of the processing units allocated to the tensor parallelism dimension.

In Example 17, the subject matter of any one or more of Examples 11-16, further comprising: determining whether a model type is a dense model without mixture-of-experts; when the model type is determined to be a dense model, setting a value of the sparse computation dimension to one; and executing the feedforward computation as a tensor-parallel feedforward computation.

In Example 18, the subject matter of any one or more of Examples 11-17, further comprising dynamically switching between the first parallelism mode and the second parallelism mode on one or more of: a per-step basis or a per-layer basis, based on latency goals or computational resource requirements.

In Example 19, the subject matter is a system comprising one or more processors to perform operations comprising: accessing a pool of processing units; during an attention computation phase of a language model inference, causing the processing units to process portions of a key-value (KV) cache in a distributed manner; after the attention computation phase, reprovisioning the pool of processing units from a first parallelism mode for attention computation to a second parallelism mode for feedforward computation; and causing the reprovisioned pool of processing units to perform feedforward computations.

In Example 20, the subject matter of Example 19, wherein during the attention computation phase, the processing units operate uniformly as a unified kernel without distinguishing between tensor parallelism or expert parallelism roles.

In Example 21, the subject matter of any one or more of Examples 19-20, wherein the second parallelism mode comprises a multi-dimensional parallelism configuration having a tensor parallelism dimension for distributing computational workload of individual experts across processing units and an expert parallelism dimension for distributing different experts across processing units.

In Example 22, the subject matter of any one or more of Examples 19-21, wherein the second parallelism mode comprises a multi-dimensional parallelism configuration following a mathematical relationship of N=TP×EP, where N is a total number of processing units, TP is a tensor parallelism degree, and EP is an expert parallelism dimension.

In Example 23, the subject matter of any one or more of Examples 19-22, wherein in the second parallelism mode, each expert is placed on an expert parallelism slice with its implementation tensor-parallelized across tensor parallelism processing units.

In Example 24, the subject matter of any one or more of Examples 19-23, wherein when the language model comprises a dense model without mixture-of-experts, the expert parallelism dimension equals one, and the second parallelism mode degrades gracefully into pure tensor-parallel feedforward execution.

In Example 25, the subject matter of any one or more of Examples 19-24, the operations further comprising performing at least one collective communication operation to exchange data between the processing units during transition from the first parallelism mode to the second parallelism mode.

In Example 26, the subject matter of any one or more of Examples 19-25, wherein the collective communication operation comprises: an all-gather operation for attention result collection followed by a local reduction and correction step; an all-reduce operation for tensor-parallel expert computation; or an all-to-all operation for regrouping token outputs post-expert computation.

In Example 27, the subject matter of any one or more of Examples 19-26, wherein the feedforward computation includes routing tokens to top-k experts and gathering the tokens accordingly within their expert group, wherein k is a positive integer.

In Example 28, the subject matter of any one or more of Examples 19-27, wherein the language model comprises a Mixture-of-Experts (MoE) architecture.

In Example 29, the subject matter of any one or more of Examples 19-28, wherein causing the processing units to process portions of the KV cache comprises distributing a sequence dimension of the KV cache across the processing units.

In Example 30, the subject matter of any one or more of Examples 19-29, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-modal language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system using or deploying one or more inference microservices; a system incorporating one or more machine learning models deployed in a service or microservice along with an OS-level virtualization package; a system implemented at least partially in a data center; or a system implemented at least partially using cloud computing resources.

What is claimed is:

1. One or more processors comprising processing circuitry to perform operations comprising:
reconfiguring a pool of processing units between a first parallelism mode for attention computation and a second parallelism mode for feedforward computation in a language model inference system,
wherein the first parallelism mode distributes contextual memory data across the pool of processing units, and the second parallelism mode reorganizes the pool of processing units into a multi-dimensional parallelism configuration having at least one tensor parallelism dimension and at least one sparse computation dimension for processing tokens through a plurality of neural networks in a sparse computation architecture.

2. The one or more processors of claim 1, wherein the first parallelism mode comprises key-value (KV) parallelism in which the pool of processing units participates in computing at least one of: one or more key projections, one or more query projections, one or more value projections, or one or more attention values.

3. The one or more processors of claim 1, wherein the sparse computation architecture comprises a Mixture-of-Experts architecture, and wherein the sparse computation dimension comprises at least one expert parallelism dimension.

4. The one or more processors of claim 1, wherein the operations further comprise performing collective communication operations to facilitate transition between the first parallelism mode and the second parallelism mode, the collective communication operations comprising at least one of: an all-gather operation, an all-reduce operation, or an all-to-all operation.

5. The one or more processors of claim 1, wherein the second parallelism mode comprises processing one or more sparse activation patterns where a subset of the plurality of neural networks is activated for each input token.

6. The one or more processors of claim 1, wherein, in the second parallelism mode, feedforward neural networks are distributed using a Tensor Parallelism (TP)×Expert Parallelism (EP) configuration.

7. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.

8. A method to perform inference in language models, comprising:
configuring a plurality of processing units in a first parallelism mode for attention computation, the first parallelism mode distributing contextual memory data across the plurality of processing units;
performing one or more attention computation operations using the plurality of processing units to process the contextual memory data;
reconfiguring the plurality of processing units from the first parallelism mode to a second parallelism mode for feedforward computation after completing the one or more attention computation operations, the second parallelism mode reconfiguring the plurality of processing units into a multi-dimensional parallelism configuration having at least one tensor parallelism dimension and at least one sparse computation dimension; and
executing feedforward neural network operations using the reconfigured plurality of processing units to generate output token probabilities for autoregressive token generation.

9. The method of claim 8, wherein the first parallelism mode comprises key-value (KV) parallelism that distributes a sequence dimension of a KV cache across the plurality of processing units, and wherein performing the attention computation operations comprises:
computing key, query, and value projections for an input token;
calculating one or more attention weights between the input token and the KV cache; and
producing a context-aware representation of the input token.

10. The method of claim 8, further comprising performing collective communication operations during transition between the first parallelism mode and the second parallelism mode, the collective communication operations comprising:
executing an all-gather operation to aggregate partial attention outputs from each processing unit in the plurality of processing units; performing a local reduction to combine the aggregated partial attention outputs into combined outputs; and
applying a correction operation to the combined outputs to maintain mathematical equivalence with non-distributed attention computation.

11. The method of claim 8, wherein reconfiguring the plurality of processing units comprises organizing the processing units according to a mathematical relationship defined by N=TP×EP, where N represents a total number of processing units, TP represents a tensor parallelism degree, and EP represents an expert parallelism degree.

12. The method of claim 8, wherein the sparse computation dimension is to process tokens through expert neural networks in a Mixture-of-Experts architecture, and the method further comprises:
placing each expert neural network on an expert parallelism slice; and
tensor-parallelizing an implementation of each expert neural network across a subset of the processing units allocated to the tensor parallelism dimension.

13. The method of claim 8, further comprising:
determining whether a model type is a dense model without mixture-of-experts;
based on the model type being determined to be a dense model, setting a value of the sparse computation dimension to one; and
executing the feedforward computation as a tensor-parallel feedforward computation.

14. A system comprising one or more processors to perform operations comprising:
during an attention computation phase of a language model inference, causing a plurality of processing units to process portions of a key-value (KV) cache in a distributed manner;
after the attention computation phase, reprovisioning the plurality of processing units from a first parallelism mode for attention computation to a second parallelism mode for feedforward computation; and
causing the reprovisioned plurality of processing units to perform feedforward computations.

15. The system of claim 14, wherein the second parallelism mode comprises a multi-dimensional parallelism configuration having a tensor parallelism dimension for distributing computational workload of individual experts across the plurality of processing units and an expert parallelism dimension for distributing different experts across the plurality of processing units.

16. The system of claim 15, wherein in the second parallelism mode, each expert of the distributed different experts is placed on an expert parallelism slice with an associated implementation tensor-parallelized across tensor parallelism processing units.

17. The system of claim 14, wherein, based on the language model comprising a dense model without mixture-of-experts, the second parallelism mode degrades into tensor-parallel feedforward execution.

18. The system of claim 14, the operations further comprising performing at least one collective communication operation to exchange data between the processing units during transition from the first parallelism mode to the second parallelism mode, wherein the at last one collective communication operation comprises at least one of:
an all-gather operation for attention result collection followed by a local reduction and correction step;
an all-reduce operation for tensor-parallel expert computation; or
an all-to-all operation for regrouping token outputs after expert processing.

19. The system of claim 14, wherein the feedforward computation includes routing tokens to top-k experts and gathering the tokens accordingly within their expert group, wherein k is a positive integer.

20. The system of claim 14, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-modal language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system using or deploying one or more inference microservices;
a system incorporating one or more machine learning models deployed in a service or microservice along with an OS-level virtualization package;
a system implemented at least partially in a data center; or
a system implemented at least partially using cloud computing resources.
